(19) United States
(12) Patent Application Publication
(10) Pub. No.: US 2011/0138073 A1
(43) Pub. Date: Jun. 9, 2011

(54) CONNECTION DESTINATION SELECTION APPARATUS AND METHOD THEREOF

(75) Inventor: Ryuta TANAKA, Kawasaki (JP)

(73) Assignee: FUJITSU LIMITED, Kawasaki-shi (JP)

(21) Appl. No.: 12/962,646

(22) Filed: Dec. 7, 2010

(30) Foreign Application Priority Data
Dec. 9, 2009 (JP) 2009-279607

(51) Int. Cl. G06F 15/173

(52) U.S. Cl. 709/241

(57) ABSTRACT

A connection destination selection apparatus, in a network in which one reception device receives data distributed from a data distribution device and transfers the data received to another one of a plurality of reception devices which is connected to the one reception device, to select a reception device that becomes a connection destination of a new reception device that newly connects to the network, the apparatus includes, a first route information retaining unit to retain, for each of the reception devices that receives the data, corresponding first route information that is route information from the data distribution device to the each reception device; a second route information acquisition unit to acquire second route information that is route information from the data distribution device to the new reception device; and a connection destination selection unit to select at least one reception device corresponding to the first route information.

### CROSS-REFERENCE TO RELATED APPLICATIONS

This application is based upon and claims the benefit of priority of the prior Japanese Patent Application No. 2009-279607 filed on Dec. 9, 2009, the entire contents of which are incorporated herein by reference.

### FIELD

The embodiments discussed herein relate to a technology in which a plurality of terminals is connected and data is broadcasted by relay transfer of data.

### BACKGROUND

In conventional server-client data distribution, as the number of data reception terminals increases, a distribution load in proportion to the number is generated at the distribution server. Thus, in a large scale system, enhancements of distribution servers on which accesses are concentrated and a network infrastructure are required. Consequently, the distribution cost becomes the issue. Against this backdrop, recently distribution that applies Peer-to-Peer (P2P) technology has attracted attention.

For P2P streaming distribution, a method is known that achieves large scale data broadcast in which a terminal that receives data relays the received data to another terminal and the data is sequentially relay-distributed from terminal to terminal. In this method, an increase in a load on a server for an increase in the number of terminals is gradual, or there is no influence on the load on the server. The P2P data distribution distributes data over a logical network formed with a logical link among terminals without regard to a physical network environment. In the P2P data distribution, an amount of data traffic that flows over an actual physical network is determined by a method to connect terminals that make up a logical network. As illustrated in FIG. 1, there is a case in which a data packet that is being relay-transferred is transferred back and forth between specific routers because a terminal that belongs to a network A and a terminal that belongs to a network B are alternately connected. In this case, the network resources are inefficiently used because the same data is transferred back and forth in the same interval.

In order to avoid the above-described condition, there is a generally known method in which a network distance between a relay terminal that is a connection destination candidate and a new terminal is measured and a relay terminal with a distance nearest from the new terminal is selected as a connection destination target. As the network distance here, the number of router hops over a route or Round Trip Time (RTT) is used. The method enables the new terminal to avoid, to a certain degree, connecting to a terminal that is far away among many connection candidate terminals. Regarding the technologies, refer to, for example, Japanese Laid-open Patent Publication Nos. 2005-056036 and 2007-251805, and “Methods on Logical Network Construction in Peer-to-Peer Services based on Traffic Measurements”, TECHNICAL REPORT OF IEICE, February 2002 CQ2001-101, pp 43-48.

### SUMMARY

In accordance with an aspect of the embodiments, a connection destination selection apparatus, in a network in which one reception device receives data distributed from a data distribution device and transfers the data received to another one of a plurality of reception devices which is connected to the one reception device, to select a reception device that becomes a connection destination of a new reception device that newly connects to the network, the apparatus includes, a first route information retaining unit to retain, for each of the reception devices that receives the data, corresponding first route information that is route information from the data distribution device to the each reception device; a second route information acquisition unit to acquire second route information that is route information from the data distribution device to the new reception device; and a connection destination selection unit to select at least one reception device corresponding to the first route information that has substantially the largest overlapped part with the second route information as a connection destination candidate of the new reception device, as a result of comparisons between the second route information and each of the first route information.

The object and advantages of the invention will be realized and attained by at least the features, elements, and combinations particularly pointed out in the claims. It is to be understood that both the foregoing general description and the following detailed description are exemplary and explanatory and are not restrictive of the various embodiments, as claimed.

### BRIEF DESCRIPTION OF DRAWINGS

These and/or other aspects and advantages will become apparent and more readily appreciated from the following description of the embodiments, taken in conjunction with the accompanying drawings of which:

FIG. 1 illustrates duplicate transmissions of a packet that is occurred over a network;

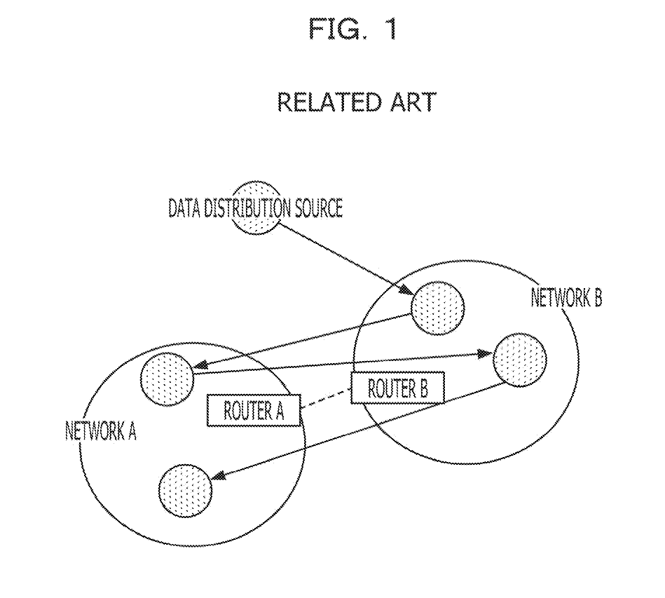

FIG. 2 illustrates duplicate transmissions of a packet that is occurred over a network to which a conventional method is applied;

FIG. 3 is a functional block diagram of a connection destination selection apparatus according to an embodiment;

FIG. 4 is a configuration example of a data distribution network according to an embodiment;

FIG. 5 illustrates a data distribution network to which a processing example by a connection destination selection apparatus according to an embodiment is applied;

FIG. 6 illustrates an example of first route information according to an embodiment;

FIG. 7 is a flowchart illustrating an example of processing by a connection destination selection apparatus according to an embodiment;

FIG. 8 is an example of second route information according to an embodiment;

FIG. 9 illustrates a result of comparison performed by a connection selection destination unit according to an embodiment;

FIG. 10 is a flowchart illustrating an example of processing by a connection destination selection apparatus according to an embodiment;

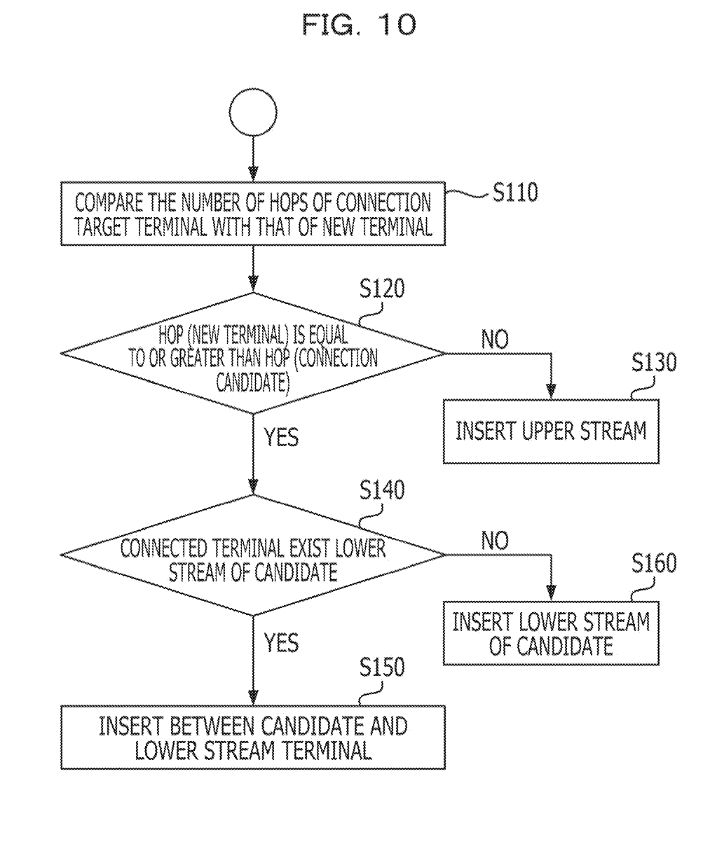

FIG. 11 is an alternative example of first route information according to an embodiment;

FIG. 12 is an alternative example of second route information according to an embodiment; and

FIG. 13 illustrates a result of comparison performed by the connection selection destination unit according to an embodiment.

### DESCRIPTION OF EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer in between the two elements, or one or more intervening elements may also be present.

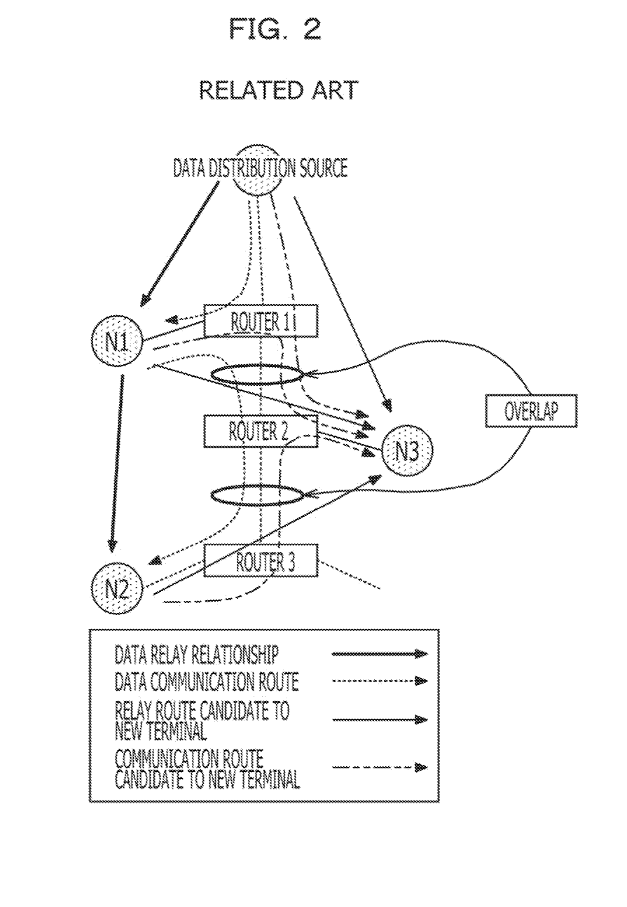

In the P2P system that allows many terminals to arbitrarily connect and cut off, there may be a drawback that selecting a terminal with a nearest network distance as a connection destination each time as described above is inefficient. For example, as illustrated in FIG. 2, a case is assumed that a terminal N3 is newly connected to a network in which a terminal N1 is connected with one hop from a distribution source, and a terminal N2 is connected with three hops from the distribution source. The network distance (the number of router hops) between the distribution source and the terminal N3, the network distance between the terminal N1 and the terminal N3, and the network distance between the terminal N2 and the terminal N3 are all two hops. However, data relayed from the distribution source is transferred back and forth or transferred in duplicate between one of the adjacent routers wherever the terminal N3 is connected.

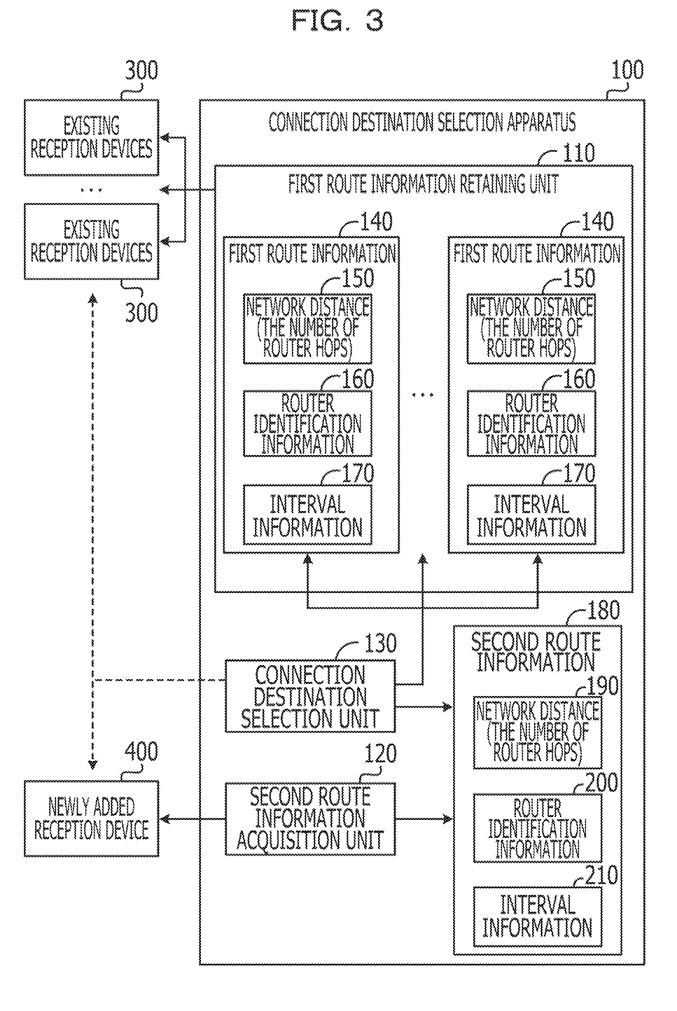

A connection destination selection apparatus 100 according to an embodiment will be described by referring to FIG. 3. Here, a case is assumed in which data distributed from a data distribution device 500 (not illustrated) is relayed among a plurality of reception devices 300 in a Peer to Peer (P2P) data distribution network.

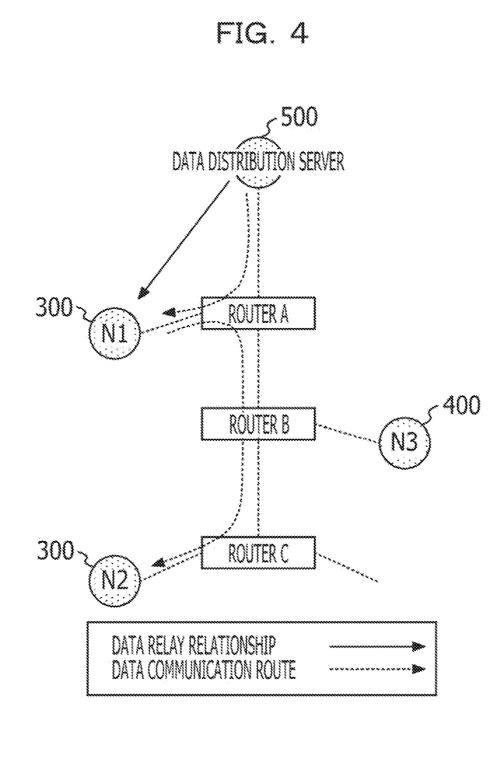

When a new reception device 400 is joined (connected) to the data distribution network, the connection destination selection apparatus 100 selects a connection destination of the reception device 400 from existing reception devices 300. For example, as illustrated in FIG. 4, when a reception device N3 is newly joined to a data distribution network in which a reception device N1 receives data from the data distribution device 500 and transfers the received data to a reception device N2, the connection destination selection apparatus 100 selects a connection destination of the reception device N3.

Moreover, the connection destination selection apparatus 100 notifies the reception device 400 of the selection result. The reception device 400 requests the notified connection destination candidate to transfer data and the reception device 300 that is the connection destination candidate responds to the request. Accordingly, the new reception device 400 may be joined to the P2P data distribution network.

The connection destination selection apparatus 100 includes a first route information retaining unit 110, a second route information acquisition unit 120, a connection destination selection unit 130, a first route information 140, and a second route information 180. The connection destination selection apparatus 100 is connected to the existing reception devices 300 illustrated as the reception device N1 and the reception device N2, and a newly added reception device 400 illustrated as the reception device N3.

The first route information retaining unit 110 retains route information between each of the existing reception devices 300 and the data distribution device 500. The route information here indicates identification information 160 of all of relay devices (for example, routers) that exist over a communication route in which the data passes through when the data is transmitted and received between the devices 300 and 500, the number of relay devices (the number of router HOPs) 150 that indicates network distances of the relay devices, and an interval information 170 that is identified by two adjacent relay devices. The identification information 160 may be an Internet Protocol (IP) address and a Media Access Control (MAC) address of a relay device.

For example, the first route information 140 for the reception device N1 illustrated in FIG. 4 is an IP address of a router A or the number of routers, “1” and the interval information is “None.” Meanwhile, the first route information 140 for the reception device N2 illustrated in FIG. 4 is an IP address of routers A, B, and C, and the number of routers “3”, the interval information is “an interval identified by the routers A and B, and an interval identified by routers B and C”. When Linux OS is installed, each reception device 300 issues a “traceroute” command in which a target host is the data distribution device 500, and acquires route information to the data distribution device 500. The first route information retaining unit 110 retains all of the respective pieces of route information acquired by each reception device 300.

The second route information acquisition unit 120 acquires a second route information 180 that is route information between the newly added reception device 400 and the data distribution device 500. For example, the second route information 180 for the reception device N3 illustrated in FIG. 4 is IP addresses of routers A and B, the number of the routers “2”, and interval information is “an interval identified by the routers A and B.” The second route information acquisition unit 120 acquires route information that is acquired by the reception device 400 by issuing a “traceroute” command in which a target host is the data distribution device 500 when Linux OS is installed in the reception device 400. The route information here indicates identification information 200 of all of relay devices (for example, routers) that exist over a communication route through which the data passes when the data is transmitted and received between the devices 400 and 500, the number of relay devices 190, and an interval information 210 identified by two adjacent relay devices.

The connection destination selection unit 130 illustrated in FIG. 3 compares each item of information of the first route information with that of the second route information 180. For example, identification information 160 and identification information 200 of relay apparatuses included in the first route information 140 and the second route information 180, or the interval information 170 and interval information 210 are mutually compared. The connection destination selection unit 130 selects the reception device 300 that corresponds to the first route information 140 with substantially the largest overlapped part as the second route information 180 based on the above-described comparison result as a connection destination candidate of the newly added reception device 400.

For example, when identification information 160 of a plurality of existing reception devices and identification information 200 of a newly added reception device in FIG. 4 are compared, the overlapped part of the devices N1 and N3 is the router A, and the overlapped part of the devices N2 and N3 is the routers A and B. Accordingly, the device N2 has a larger overlapped part, and thereby the connection destination selection unit 130 selects the device N2 as a connection destination candidate for the device N3. Likewise, in FIG. 4, when the interval information 170 of the plurality of the existing reception devices and the interval information 210 of the newly added reception device are compared, there is no overlapped part regarding the devices N1 and N3, and the overlapped part regarding the devices N2 and N3 is an interval identified by the routers A and B. Accordingly, the device N2 has more overlapped part, and the connection destination selection unit 130 selects the device N2 as a connection destination candidate for the device N3.

Moreover, when the plurality of the reception devices 300 is selected by the above-described processing, the connection destination selection unit 130 illustrated in FIG. 3 compares the number of relay devices 150 included in respective pieces of the first information 140 of the selected plurality of reception devices 300. As a result of the comparison, the connection destination selection unit 130 selects one reception device 300 with substantially the smallest number of the relay devices 150.

Moreover, after selecting one reception device 300, the connection destination selection unit 130 illustrated in FIG. 3 compares the number of relay devices 150 for the selected reception device 300 with the number of relay devices 190 for the newly added reception device 400. When the number of the relay devices 190 for the reception device 400 is greater than the number of relay devices 150 for the selected reception device 300, the connection destination selection unit 130 selects the selected reception device 300 as the connection destination of the reception device 400. Moreover, when another reception device 300 is connected to the selected reception device 300 in which the selected reception device 300 is a transfer source of the another reception device 300, the another reception device 300 is connected to the reception device 400 for which the selected reception device 300 is selected as the connection destination, in this case, the reception device 400 is a transmission source of the another reception device 300. In other words, the connection destination selection unit 130 makes a selection so that the reception device 400 is inserted between the two reception devices 300 that relay data.

Meanwhile, when the number of relay devices 190 for the reception device 400 is less than the number of relay devices 150 for the selected reception device 300 illustrated in FIG. 3, the connection destination selection unit 130 selects a reception device 300 that is a connection source of the selected reception device 300 as the connection destination of the reception device 400. Moreover, the connection destination selection unit 130 selects the reception device 400 as a new connection destination of the selected reception device 300. In other words, the connection destination selection unit 130 makes a selection so that the reception device 400 is inserted at an upper stream side of the selected reception device 300.

In the example of FIG. 4, after selecting the device N2 as a connection candidate for the device N3, the connection destination selection unit 130 compares the number of relay devices 150 for the device N2 with the number of relay devices 190 for the device N3. The connection destination selection unit 130 selects the device N3 as a data transfer destination of the device N1 and the device N2 as a data transfer destination of the device N3 because the number of relay devices 190 for the device N3 is less than the number of relay devices 150 for the device N2. In other words, the connection destination selection unit 130 makes a selection so that the device N3 is inserted at an upper stream side of the device N2.

The connection destination selection apparatus 100 notifies the reception devices 300 and 400 of the selection result by the connection destination selection unit 130. The reception devices 300 and 400 request the notified connection destinations to transfer data. Through the above-described processing, the P2P data distribution network may make the new reception device 400 join the network.

Based on the above-described operation principle, the disclosed connection destination selection apparatus 100 may efficiently utilize the network resources by appropriately selecting a connection destination of a new terminal, when the new terminal is added to the P2P system that relay transfers data.

The connection destination selection apparatus 100 illustrated in FIG. 3 includes a Central Processing Unit (CPU), a Read-Only Memory (ROM), and a Hard Disc Drive (HDD). Each of the units included in the connection destination selection apparatus 100 is implemented by causing the CPU to execute a program for each unit stored in the ROM or the HDD. Moreover, each unit of the connection destination selection apparatus 100 may be implemented by hardware that performs processing of each unit.

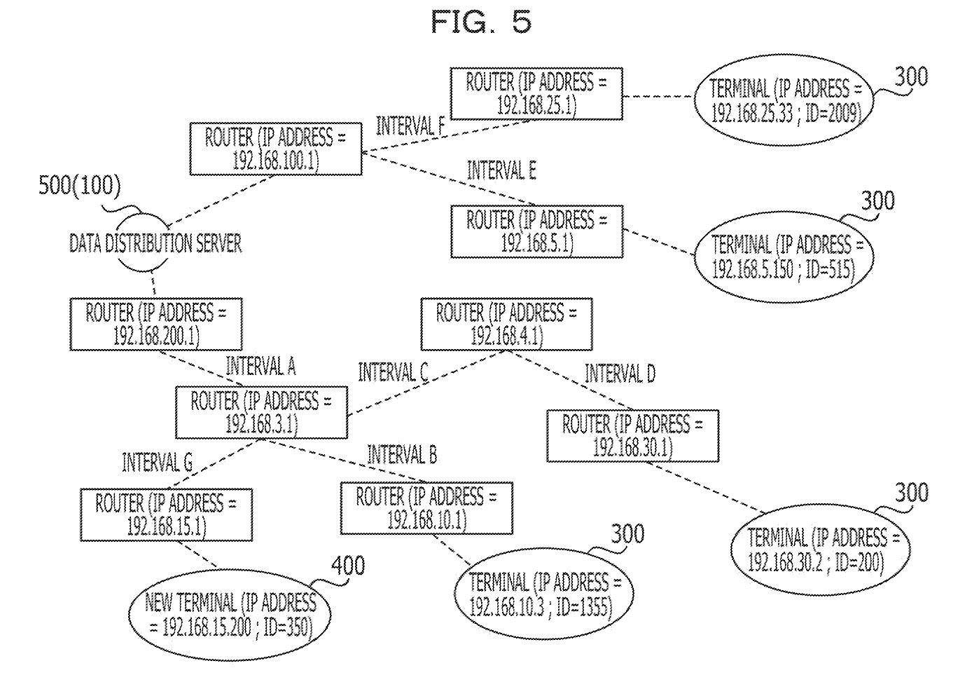

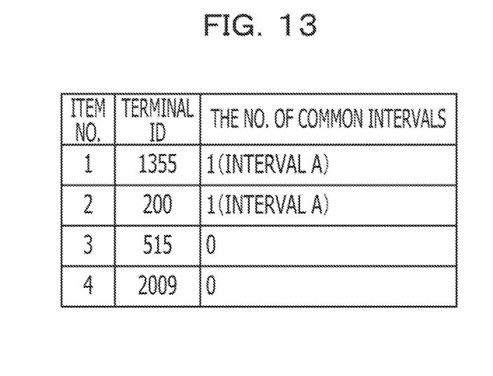

An example of processing by the connection destination selection apparatus 100 will be described by referring to FIG. 5 and FIG. 13. Here, as illustrated in FIG. 5, processing in which the connection destination selection apparatus 100 selects a connection destination of a terminal 400 will be described when the terminal 400 is newly connected to a P2P system in which streaming data distributed by the data distribution server 500 is relay transferred among terminals 300. In the P2P system according to the processing, it is assumed that terminals 300 with terminal IDs 1355, 200, 515, and 2009 respectively are initially connected, and a terminal 400 with a terminal ID350 is newly connected. A network protocol for the P2P system may perform data communication by general internet protocols such as Transmission Control Protocol (TCP) and User Datagram Protocol (UDP).

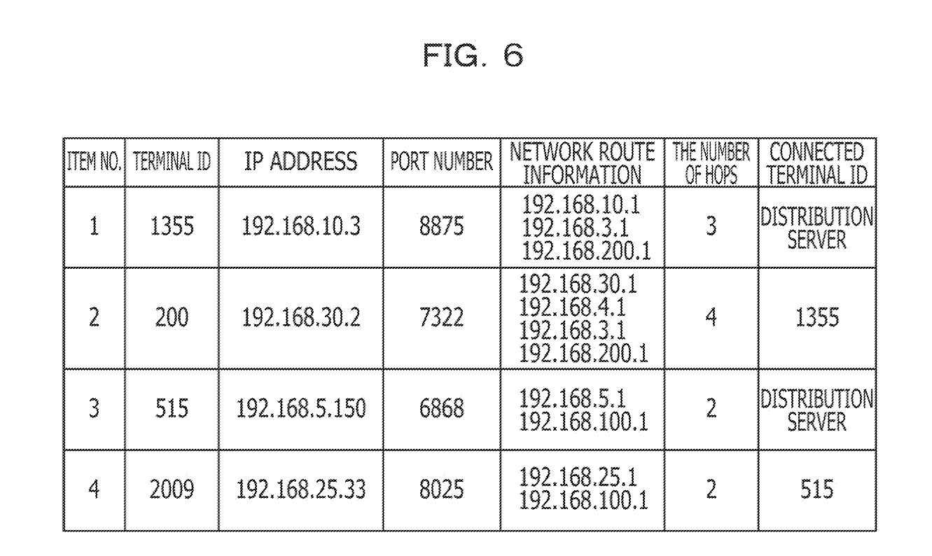

According to the processing, the data distribution server 500 is assumed to provide functions of the connection destination selection apparatus 100. However, a device other than the data distribution server 500, for example, each of the terminals 300 and 400, or another external device may function as the connection destination selection apparatus 100. The data distribution server 500 according to the processing example is assumed to retain the first route information 140 as illustrated in FIG. 6. However, the first route information retaining unit 110 may acquire the first route information 140 from each of the existing reception devices 300 when the terminal 400 is newly connected.

In FIG. 6, for example, the terminal 300 with the terminal ID1355 has an IP address, “192.168.10.3”, and a port number “8875.” Moreover, the terminal 300 with the terminal ID1355 is connected to the distribution server 500 through routers, “192.168.10.1”, “192.168.3.1”, and “192.168.200.1.” FIG. 6 indicates that the network distance between the terminal 300 with the terminal ID1355 and the distribution server 500, in other words, the number of hops is “3.”

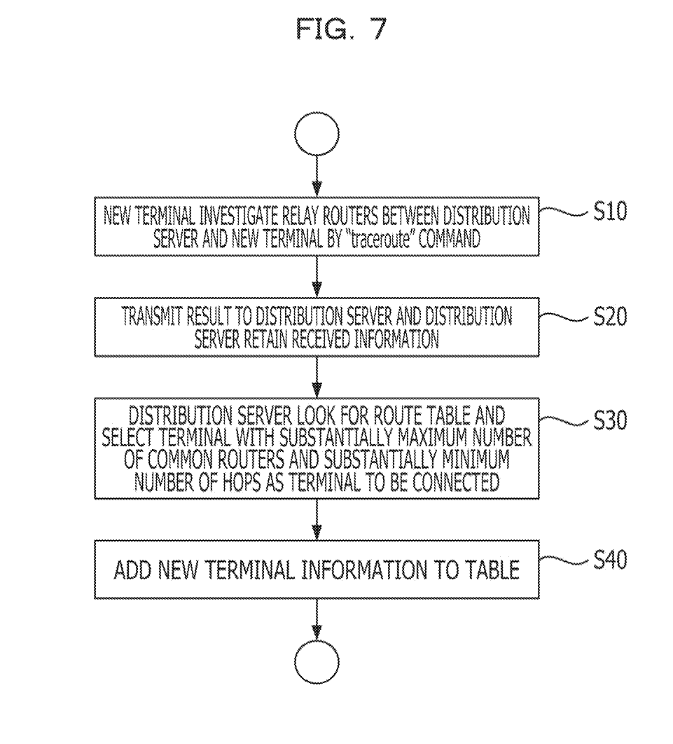

FIG. 7 is a flowchart illustrating an example of processing by the connection destination selection apparatus 100 of the data distribution server 500.

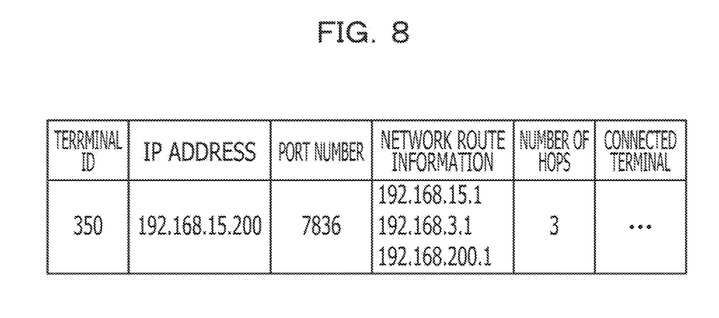

In operation S10, the terminal 400 to be newly connected to the P2P system issues a “traceroute” command to find routers that relay the distribution server 500 and the terminal 400. Here, it is assumed that the terminal 400 is installed with Linux OS and may use the “traceroute” command. The “traceroute” command is issued in which a target host is the distribution server 500. A list of identification information of routers (for example, IP address) that relay a source where command is issued and the target host illustrated in FIG. 8 may be acquired.

In operation S20, the terminal 400 notifies the distribution server 500 of its own terminal ID, IP address, port number and a list of routers acquired by the “traceroute” command, and the number of hops (the number of routers that made up the list). Through the processing, the second route information acquisition unit 120 of the distribution server 500 acquires the terminal ID, IP address, port number, list of routers, and the number of hops that made up a second route information 180.

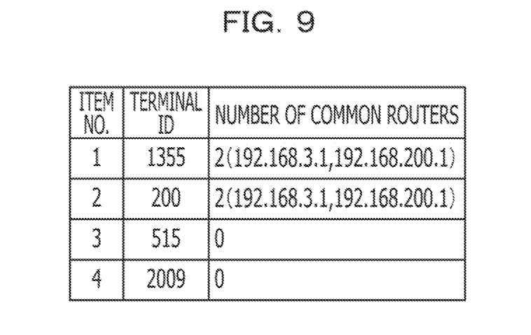

In operation S30, the connection destination selection unit 130 of the distribution server 500 compares network route information of each of the first route information 140 illustrated in FIG. 6 with the network route information of the second route information 180 illustrated in FIG. 8, and extracts common routers and the number of the routers for each of the terminals 300. In the operation S30, the connection destination selection unit 130 selects a terminal 300 that has substantially maximum number of common routers as a connection destination candidate of the terminal 400. As illustrated in FIG. 9, in the processing example, the number of common routers for two terminals 300 with the terminal IDs 1355 and 200 is “2.” Thus, the connection destination selection unit 130 selects the two terminals 300 with the terminal IDs 1355 and 200 as the connection destination candidates of the terminal 400.

Moreover, in operation S30, the connection destination selection unit 130 compares, regarding terminals 300 with the terminal IDs 1355 and 200, the number of hops 150 of the first route information 140 illustrated in FIG. 6 and finally selects the terminal 300 with the terminal ID1355 that has smaller number of hops 150 as a connection destination of the terminal 400. The above-described processing allows the disclosed connection destination selection apparatus 100 to suppress wasteful data transmission and reception at relay transfer of data and to efficiently utilize the network resources. In operation S40, the connection destination selection unit 130 additionally records the “terminal ID”, “port number”, “network route information”, “the number of hops”, and “connection terminal ID 1355” into the first route information 140 illustrated in FIG. 6.

The connection destination selection apparatus 100 of the data distribution server 500 determines a connection relationship between the terminal 300 with ID 1355 (hereinafter, called the selected terminal 300) selected at S30 and the terminal 400 with ID 350. In S110, the connection destination selection unit 130 compares the number of hops 150 of the selected terminal 300 with ID 1355 with the number of hops 190 of the terminal 400.

When the number of hops 150 of the selected terminal 300 with ID 1355 is greater than the number of hops 190 of the terminal 400 (No at S120), in other words, the network distance of the selected terminal 300 with ID 1355 is further with respect to the distribution server 500, the connection destination selection unit 130 sets a connection so that the terminal 400 is connected to an upper stream side of the selected terminal 300 with ID 1355 at S130. In other words, the connection destination selection unit 130 selects the connection destination of the selected terminal 300 with ID 1355 (the distribution server 500 in the processing example) as the selection destination of the terminal 400 and selects the terminal 400 as a connection destination of the selected terminal 300 with ID 1355, and reflects the selection to the first route information 140 illustrated in FIG. 6.

The connection destination selection unit 130 sets so that the terminal 400 is inserted between the terminals for the following case: when the number of hops 190 of the terminal 400 is equal to or greater than the number of hops 150 of the selected terminal 300 with ID 1355 (Yes at S120), and when the selected terminal 300 with ID 1355 transfers data to another terminal 300 (hereinafter called a transfer destination terminal) (Yes at S140). In other words, the connection destination selection unit 130 modifies the first route information 140 so that the connection destination of the transfer destination terminal 300 becomes the terminal 400. As illustrated in FIG. 6, in the processing example, the terminal 300 with the terminal ID1355 transfers data to the terminal 300 with the terminal ID200, thus, the connection destination selection unit 130 reflects in the first route information 140 that the connection destination of the terminal 300 with ID200 is the terminal 400 with the terminal ID350.

When the number of hops 190 of the terminal 400 is equal to or greater than the number of hops of connected terminal 300 with ID 1355 (Yes at S120), and when the connected terminal 300 with ID 1355 does not transfer data to another terminal (No at S140), the settings set by the connection destination selection unit 130 at S160 is not changed. By not changing the settings, the connection destination selection apparatus 100 of the data distribution server 500 may suppress wasteful data transmission and reception after newly connecting the reception device 400, and thereby the network resources may be efficiently utilized.

The connection destination selection apparatus 100 of the data distribution server 500 notifies all of the terminals 300 and 400 in which the settings are changed in the first route information 140 of connection destination candidates (connection destinations). Each of the terminals 300 and 400, which receive the notification, requests each connection destination candidate to transfer data. A response by each connection destination candidate to the transfer request allows the terminal 400 to be newly connected to the P2P system that relay-transfers streaming data distributed by the distribution server 500 among terminals 300.

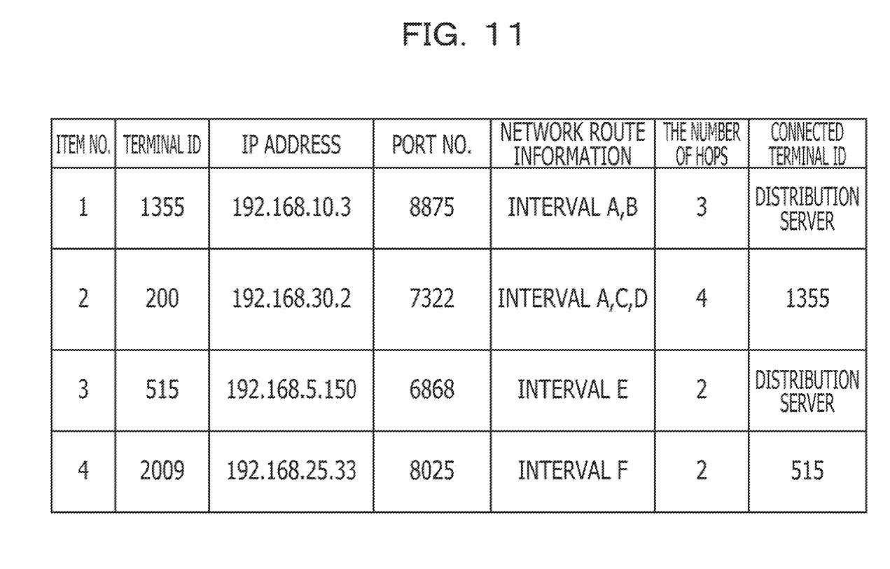

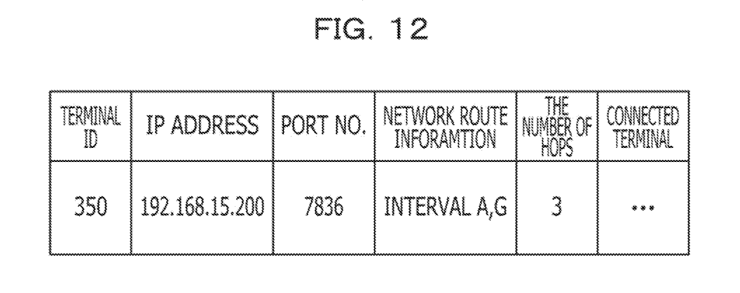

Moreover, when network route information of the first route information 140 and the second route information 180 are represented by interval information 170 and 210 that are identified by two routers as illustrated in FIG. 11 and FIG. 12 respectively, processing similar to as described-above is performed. In this case, at S30, the connection destination selection unit 130 of the distribution server 500 compares the network route information of the first route information 140 illustrated in FIG. 11 with that of the second route information 180 illustrated in FIG. 12, and extracts common intervals and the number for each terminal 300. The connection destination selection unit 130 selects a terminal 300 with the number of common intervals is substantially maximum as a connection destination of the terminal 400.

In the processing example, as illustrated in FIG. 13, regarding the two terminals 300 with the terminal ID 1355 and 200, the number of common routers is “1.” Thus, the connection destination selection unit 130 selects the two terminals 300 with the terminal ID 1355 and 200 as selection destinations of the terminal 400. Other processing operations (S10, S20, S40, S110 and S160) are, substantially the same as described above.

When the terminal 400 is connected between two terminals that are already relay-transferring data, it is desired in streaming distribution that continuity of data transmission is not lost. In this case, generally, the relay sequence is adjusted so that the continuity is not lost by referring to a sequence number allocated to unit data in order to confirm the continuity of data. For example, in FIG. 4, when relay is performed in the order of N1 to N2 from the distribution source 500, a new terminal N3 is inserted between N1 and N2. Data transfer from N1 to the new terminal N3 is started without stopping data transfer between the N1 and the N2. The new terminal N3 starts data transfer to the N2, and the N2 requests N1 to stop transmission after confirming the sequence number of data received from N1 and the sequence number of data transferred from the new terminal N3 is continuous (is synchronized) in a reception buffer. Accordingly, data continuity of streaming distribution is not influenced even if the new terminal N3 is inserted in the middle of the relay distribution route.

The first route information may be created by adding newly acquired second route information to the first route information to update whenever a new terminal is added without communicating with the existing reception terminals 300 every time to acquire the first route information. It is assumed in the above description, all of the terminals 300 and newly joined terminal 400 have transfer functions. However, there may be a terminal without any transfer function. Substantially the same processing as described above may be possible by setting a condition that a terminal with no transfer function may not become a connection destination of a transfer source in the above-described processing.

As described above, when a terminal is newly added to P2P system that relay-transfers data, according to the disclosed connection destination selection apparatus, the network resources may be efficiently utilized by appropriately selecting a reception device that becomes a connection destination of the new terminal.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments of the present invention have been described in detail, it should be understood that the various changes, substitutions, and alterations could be made hereto without departing from the spirit and scope of the invention.

What is claimed is:

1. A connection destination selection apparatus, in a network in which one reception device receives data distributed from a data distribution device and transfers the data received to another one of a plurality of reception devices which is connected to the one reception device, to select a reception device that becomes a connection destination of a new reception device that newly connects to the network, the apparatus comprising:
a first route information retaining unit to retain, for each of the reception devices that receives the data, corresponding first route information that is route information from the data distribution device to the each reception device;
a second route information acquisition unit to acquire second route information that is route information from the data distribution device to the new reception device; and
a connection destination selection unit to select at least one reception device corresponding to the first route information that has substantially the largest overlapped part with the second route information as a connection destination candidate of the new reception device, as a result of comparisons between the second route information and each of the first route information.

2. The apparatus according to claim 1, wherein
each of the first route information and the second route information includes identification information of each relay device that exists over a communication route between the data distribution device and the corresponding reception device

3. The apparatus according to claim 1, wherein
each of the first route information and the second route information includes at least one piece of interval information identified by adjacent two relay devices over a communication route between the data distribution device and the corresponding reception device; and
the comparisons between the second route information and each of the first route information include comparisons between the piece of interval information of each of the first route information and the piece of interval information of the second route information.

4. The apparatus according to claim 2, wherein
each of the first route information and the second route information further includes at least one piece of interval information identified by adjacent two relay devices over a communication route between the data distribution device and the corresponding reception device; and
the comparisons between the second route information and each of the first route information include comparisons between the piece of interval information of each of the first route information and the piece of interval information of the second route information.

5. The apparatus according to claim 1, wherein
each of the first route information includes network distance information between the data distribution device and the corresponding reception device;
the at least one reception device selected includes more than one reception devices; and
the connection destination selection unit further selects a reception device with substantially the smallest network distance information among the more than one reception device already selected by the connection destination selection unit.

6. The apparatus according to claim 2, wherein
each of the first route information includes network distance information between the data distribution device and the corresponding reception device;
the at least one reception device selected includes more than one reception device; and
the connection destination selection unit further selects a reception device with substantially the smallest network distance information among the more than one reception device already selected by the connection destination selection unit.

7. The apparatus according to claim 3, wherein
each of the first route information further includes network distance information between the data distribution device and the corresponding reception device;
the at least one reception device selected includes more than one reception device; and
the connection destination selection unit further selects a reception device with substantially the smallest network distance information among the more than one reception device already selected by the connection destination selection unit.

8. The apparatus according to claim 4, wherein
each of the first route information further includes network distance information between the data distribution device and the corresponding reception device;
the at least one reception device selected includes more than one reception device; and
the connection destination selection unit additionally selects a reception device with substantially the smallest network distance information among more than one reception device already selected by the connection destination selection unit.

9. The apparatus according to claim 5, wherein
each of the network distance information identifies the number of relay devices exists over a route between the data distribution device and the corresponding reception device; and
the connection destination selection unit additionally selects the reception device with substantially the smallest network distance information by selecting the network distance information that identifies the smallest number of relay devices.

10. The apparatus according to claim 5, wherein
the second route information includes the number of the relay devices exists over a route between the data distribution device and the new reception device; and
the connection destination selection unit selects a connection destination of the further-selected reception device as a connection destination of the new reception device when the number of the relay devices for the new reception device is less than the number of the relay devices for the reception device further-selected by the connection destination selection unit, and further, selects the new reception device as a connection destination of the data transfer source of the further-selected reception device.

11. A connection destination selection method for a connection destination selection apparatus in a network in which one reception device receives data distributed from a data distribution device and transfers the data received to another one of a plurality of reception devices which is connected to the one reception device, to select a reception device that becomes a connection destination of a new reception device that newly connects to the network, the method comprising:
retaining, by a first route information retaining unit of the connection destination selection apparatus, for each of the reception devices that receives the data, corresponding first route information that is route information from the data distribution device to the each reception device;
acquiring, by a second route information acquisition unit of the connection destination selection apparatus, second route information that is route information from the data distribution device to the new reception device;
comparing, by a connection destination selection unit of the connection destination selection apparatus, each of the first route information with the second route information; and
selecting a reception device corresponding to the first route information with substantially the largest overlapped part with the second route information as a connection destination of the new reception device as a result of the comparing.
